(19) United States
(12) Patent Application Publication
(10) Pub. No.: US 2009/0283729 A1
(43) Pub. Date: Nov. 19, 2009

(54) Extendable handle leverage ratchet

(76) Inventors: Jesse P. Carlson, Chagrin Falls, OH (US); David M. Pehar, Mayfield Heights, OH (US)

Correspondence Address: MCDONALD HOPKINS LLC, 600 Superior Avenue, East, Suite 2100, CLEVELAND, OH, 44114-2653, US

(21) Appl. No.: 12/387,686

(22) Filed: May 6, 2009

Related U.S. Application Data
(60) Provisional application No. 61/126,605, filed on May 6, 2008.

(51) Int. Cl. B60P 7/06; B25B 25/00

(52) U.S. Cl. 254/218; 24/68 CD

(57) ABSTRACT

A ratchet mechanism for securing cargo that may include a body, a ratchet, a lever and an adjustable or extendable handle. The ratchet may include a pair of opposing arms connected to the body and a spool rotatably connected to the arms. The lever may be rotatably attached to the arms and reciprocated between an open position and a closed position, wherein the lever may include at least one pawl to engage the ratchet wheels and rotate the spool when the lever is reciprocated. The handle may be adjustable to increase the mechanical advantage of the lever. The handle may be rotatably connected to the lever to extend the length of the lever. The handle may be slidably connected to the lever, to slide between a compact position where the handle is closer to the spool, and an extended position where the handle extends further away from the spool.

### CROSS-REFERENCE TO RELATED APPLICATIONS

This application claims benefit from U.S. Provisional Patent Application No. 61/126,605, entitled “Pivoting Handle Leverage Ratchet,” filed on May 6, 2008, which is hereby incorporated in its entirety by reference.

### FIELD OF THE INVENTION

The present invention relates generally to a securing mechanism, and more specifically, to a ratchet mechanism having an extendable handle.

### BACKGROUND

Consumer goods, manufacturing materials, personal effects, and other such cargo are regularly shipped from one location to another. Such cargo is often shipped commercially in trucks, trains, ships, and other such transport vehicles, with the cargo secured to a specific location on the bed of a truck, haul or deck of a ship, etc. Consumers frequently secure such cargo to a roof rack of a sports utility vehicle, the bed of a light-duty pickup truck, or to the bed of a trailer. Typically, cargo is secured to prevent the cargo from shifting during shipping. Securing the cargo, limits or eliminates any damage to the cargo, damage to other nearby cargo, damage to transport vehicles, and injury to personnel handling the cargo.

Ratchet and strap tightening devices are well know for removing slack in straps and securing the straps in a tensioned condition to secure loads or cargo for hauling or transport. In the prior art, belt type mechanisms or lengths of material are commonly used to retain a load, cargo or structure in place. For example, belts are frequently used to retain stacked articles in place on a pallet are commonly employed on vehicles and trailers to secure cargo or items.

Typical securing mechanisms or cargo tighteners often include a ratchet mechanism with two straps. The first (and generally short) strap is firmly secured at one end to the mechanism and is connected at the other end to an anchor point or mounting structure on a vehicle or trailer. The second strap is also capable of being attached at one end to a mounting structure on the vehicle or trailer. The second strap is typically connected to a rotatable shaft on the ratchet mechanism so that the connecting member on the second strap may be drawn out and connected to a mounted structure. As the mechanism is ratcheted and the shaft rotates, the second strap is wound about the rotatable shaft so that the second strap tightens down over the cargo in a tensioned condition to secure the load.

One method of securing cargo to a specific location in a transport vehicle is to place webbing, straps, or other such restraint members over the cargo, secure the restraints to anchor points, and then tighten the restraints by placing the restraints in tension. Restraints are commonly placed in tension by a ratchet mechanism. Often, such an apparatus or mechanism is referred to as a ratchet tie-down system.

Typically, prior art ratchet tie-down systems may operate as follows. Webbing or other restraint members are placed around the cargo. A first end of a restraint is secured to an anchor point, such as a fixed hook or bracket. The opposite end of the restraint is passed through a ratchet mechanism, which is directly or indirectly attached to an anchor point.

The ratchet is arranged such that when a ratcheting lever is reciprocated between open and closed positions, a portion of the restraint is drawn through the ratchet and tension force of the restraint is increased. This increase in tension force further secures the cargo. The more the ratchet is moved to draw in the restraint, the greater the tension force on the restraint.

In order to minimize the overall size of such ratchet assemblies, they are often supplied with small handles for ratcheting the mechanism. The amount of tension placed on the restraints by the ratchet is often limited by the leverage supplied by the handle, thereby making it difficult to secure the cargo. Under-tightening is especially an issue when securing cargo that may be prone to shifting, such as furniture, antiques, bulky hollow parts, etc., for example.

Therefore, there is a need in the art for an improved ratchet mechanism that may overcome these and other drawbacks. The ratchet mechanism may also include an extendable handle.

### DESCRIPTION OF THE DRAWINGS

Objects and advantages together with the operation of the embodiments may be better understood by reference to the following detailed description taken in connection with the following illustrations, wherein:

FIG. 1 illustrates a perspective view of an embodiment of a ratchet mechanism.

FIG. 2 illustrates a side view of the ratchet mechanism of FIG. 1.

FIG. 3 illustrates a top view of the ratchet mechanism of FIG. 1.

FIG. 4 illustrates a perspective view of an alternate embodiment of a ratchet mechanism.

FIG. 5 illustrates a top view of the ratchet mechanism of FIG. 4.

FIG. 6 illustrates a section view of the ratchet mechanism of FIG. 5 taken along line A-A.

FIG. 7 illustrates a perspective view of an alternative embodiment of a ratchet mechanism.

FIG. 8 illustrates a side view of the ratchet mechanism of FIG. 7

FIG. 9 illustrates a top view of the ratchet mechanism of FIG. 7.

FIG. 10 illustrates a partial exploded view of the ratchet mechanism of FIG. 7.

FIG. 11 illustrates a partial exploded view of the ratchet mechanism of FIG. 7

FIG. 12 illustrates a perspective view of the ratchet mechanism of FIG. 7 showing the handle in an extended position.

FIG. 13 illustrates a perspective view a ratchet mechanism of FIG. 7 showing the handle in a collapsed or compact position.

FIG. 14 illustrates an exploded view of the ratchet mechanism of FIG. 7.

FIG. 15 illustrates a perspective view of an alternative embodiment of a ratchet mechanism.

FIG. 16 illustrates a perspective view of an alternative embodiment of a ratchet mechanism showing a handle in an extended position.

FIG. 17 illustrates a perspective view of the ratchet mechanism of FIG. 16 showing the handle in a collapsed or compact position.

FIG. 18 illustrates a side view of the ratchet mechanism of FIG. 16 being positioned between a compact position and an extended position.

### SUMMARY OF THE INVENTION

A ratchet mechanism including a body configured to receive a strap, a pair of opposing arms connected to the body, and a spool rotatably connected to the opposing arms, the spool configured to wind the strap. The mechanism also includes at least one ratchet wheel connected to opposing ends of the spool, a lever attached to the arms and reciprocated between an open position and a closed position, wherein the lever includes at least one pawl to engage the at least one ratchet wheel and rotate the spool when the lever is reciprocated, and wherein the lever is extendable away from the spool to increase the mechanical advantage of the lever.

A ratchet mechanism including a body configured to receive a strap, a pair of opposing arms connected to the body and a spool in rotatable engagement with the opposing arms, the spool capable of winding the strap. The ratchet mechanism also includes a pair of ratchet wheels connected to opposing ends of the spool, a lever attached to the arms and reciprocated between an open position and a closed position, wherein the lever includes at least one pawl to engage the ratchet wheels thereby rotating the spool when the lever is reciprocated, and a handle having a first end rotatably connected to the lever and a second end capable of rotating about the first end to extend the length of the lever and increase the mechanical advantage of the lever.

A ratchet mechanism including a body configured to receive a strap, a pair of opposing arms connected to the body, a spool in rotatable engagement with the opposing arms, the spool capable of winding he strap, and a pair of ratchet wheels connected to opposing ends of the spool. The ratchet mechanism also includes a lever attached to the arms and reciprocated between an open position and a closed position, wherein the lever includes at least one pawl to engage the ratchet wheels thereby rotating the spool when the lever is reciprocated, and a handle slidably connected to the lever, the handle slidable between a compact position wherein the handle is closer to the spool, and an extended position wherein the handle extends further away from the spool.

### DETAILED DESCRIPTION

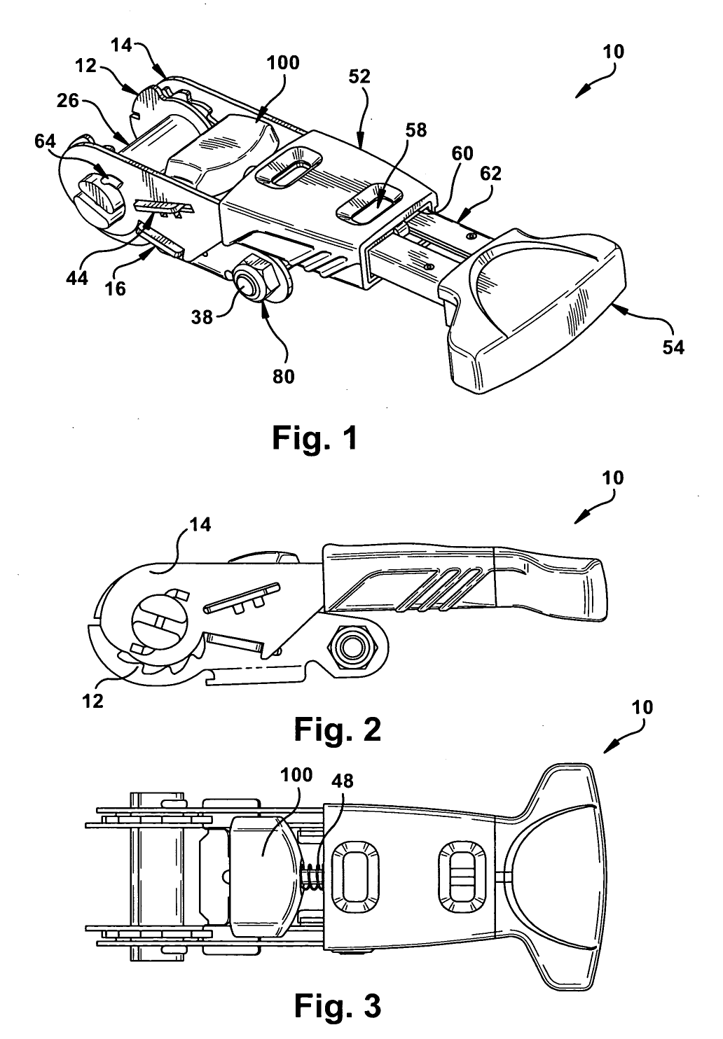

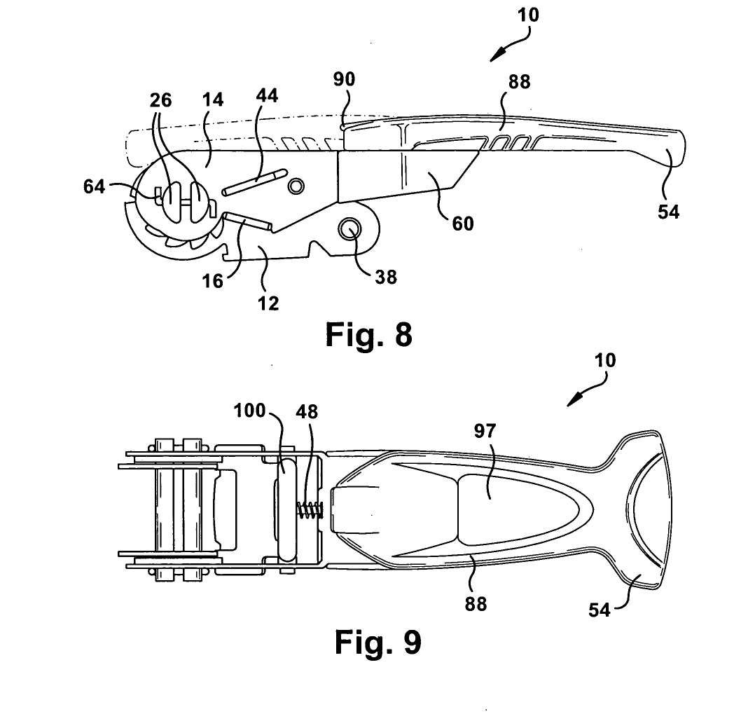

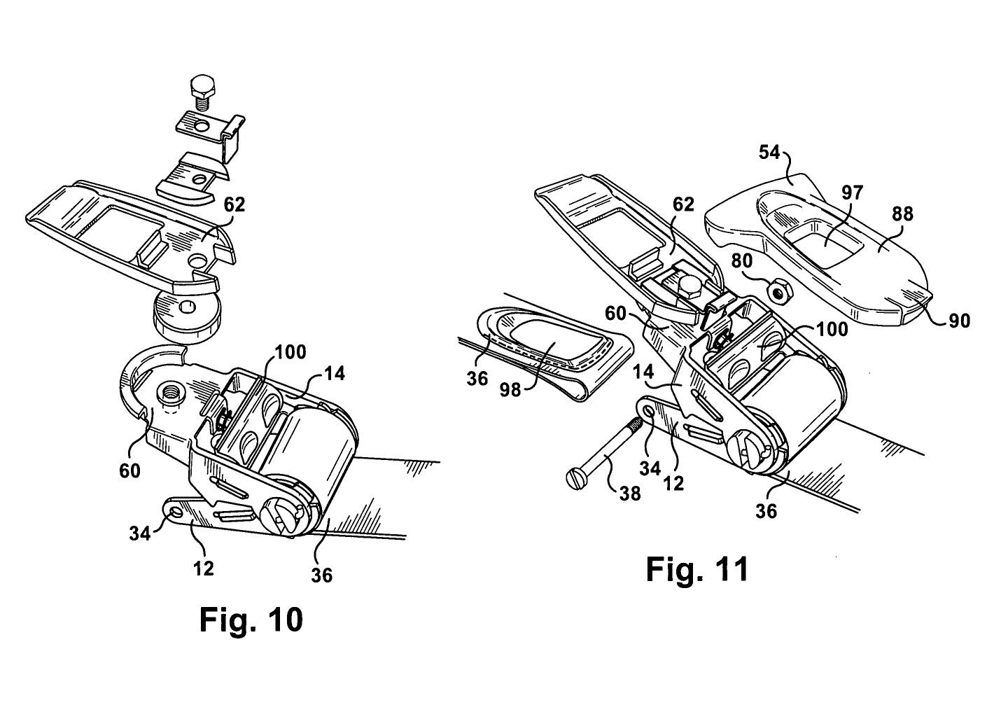

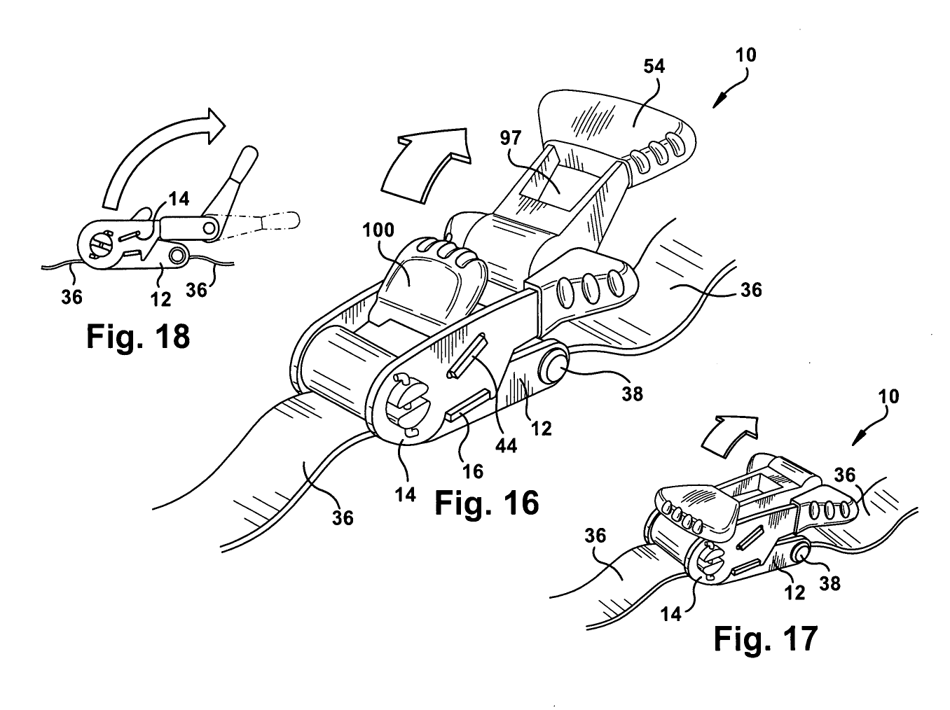

FIGS. 1-18 illustrate embodiments of an extendable handle leverage ratchet 10 (hereinafter “the ratchet mechanism 10” or “the mechanism 10”). The mechanism 10 may combine the function and benefits of a typical ratchet mechanism into an improved securing mechanism that provides for an extendable handle, which may result in additional leverage being supplied to the handle to ensure the proper amount of tightening is met, while also speeding up the time it takes to secure a load or cargo.

As best shown in FIGS. 1, 4 and 7, the ratchet mechanism 10 may include a base 12, an upper body 14, bails or a spool 26, ratchet gears 28, and a lever 60. The lever 60 may include an extension member 62.

As shown in FIGS. 1, 4 and 8, the base 12 may be configured to be rotatably attached to a pair of bails or a spool 26. The spool 26 may be secured to the base 12 with one or more sidewalls 17. The pair of sidewalls 17 may be located approximately parallel to one another. Each sidewall 17 may include an aperture 24 for attachment to the spool 26. The apertures 24 in the sidewalls 17 may be of any appropriate shape or size, such as circular, for example. The pair of semicircular bails or the spool 26 may be rotatably positioned in the apertures 24 of the base 12. The bails 26 may be moveably positioned such that the bails 26, as a pair or a spool 26, rotate within the circular apertures 24.

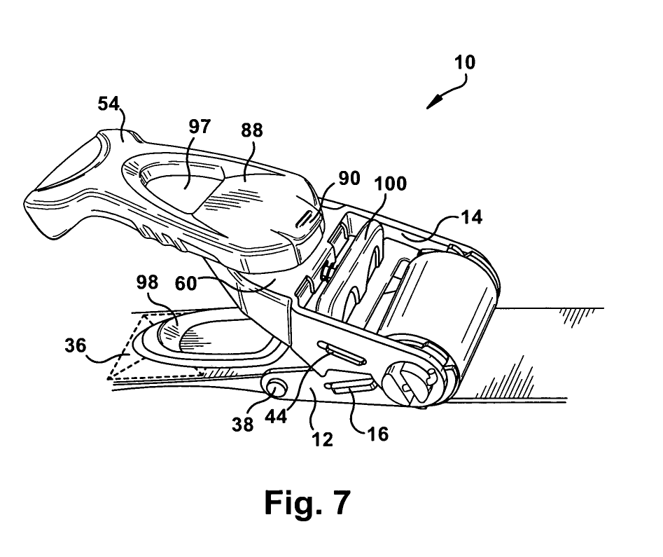

A lower pawl 16 may be moveably positioned in the base 12 through two matching slots 18 in opposing sidewalls 17 of the base 12. The lower pawl 16 may include at least one tab 20. The tabs 20 may extend from the lower pawl 16 and may be sized to fit into the pair of slots 18 in the base 12 sidewalls 17. The tabs 20 and slots 18 may be arranged to allow limited lateral movement of the lower pawl 16 with respect to the base 12 between extended and retracted positions. The mechanism 10 may also include a lower pawl spring 22. The lower pawl spring 22 may be positioned behind the lower pawl 16 to encourage the lower pawl 16 into the extended position, as seen in FIG. 7.

The upper body 14 may also include at least one sidewall 42. The sidewalls 42 may be used to secure the spool 26 to the upper body 14. The upper body 14 may include a pair of matching aperture 40 in the opposing sidewalls 42 of the upper body 14. A pair of semicircular bails or a spool 26 may be rotatably positioned in the aperture 40 of the upper body 14. The bails 26 may be moveably positioned such that the bails 26, as a pair or a spool 26, rotate within the aperture 40.

As shown in FIGS. 1, 4 and 8, the upper body 14 may be configured to be rotatably attached to the bails or spool 26. The spool 26 may be secured to the upper body 14 with one or more sidewalls 42. The pair of sidewalls 42 may be located approximately parallel to one another. Each sidewall 42 may include an aperture 40 for attachment to the spool 26. The aperture 40 in the sidewalls 42 may be of any appropriate shape or size, such as circular, for example.

As best shown in FIGS. 1, 4, 8 and 14, the spool 26 may be of any appropriate shape or size, so that the spool 26 may gather the strap 36 around its outer surface as it is rotated.

For example, the spool 26 may be of a generally cylindrical shape. In a non-limiting example, as shown in FIGS. 1, 4 and 8, the spool 26 may include two halves or bails 26.

As shown in FIGS. 1, 4 and 8, the two bails or the spool 26 may be secured together by any appropriate means, such as by fasteners 64. The fasteners 64 may be of any appropriate shape, size or type, such as a bolt, screw, retaining wire or pin, for example. It is to be understood, however, that one of ordinary skill in the art will appreciate that any variety of appropriate configurations may be used for rotatably securing the spool 26 to the base 12 and upper body 14 and should not be limited to the examples provided herein.

The ratchet gears 28 and washers 30 may be mounted to the bails 26 through the washer 30 and semicircular apertures 32 in the gears 28. As best seen in FIG. 9, a front edge of the lower pawl 16 may engage the teeth of the gears 28 when the ratchet is assembled. This engagement allows the gears 28 to rotate in only one direction. As the gears 28 rotate in the allowed direction, the lower pawl 16 may retract by compressing the lower pawl spring 22. When the gears 28 attempt to rotate in the opposite direction, movement may be blocked by engagement between the lower pawl 16 with the gears 28.

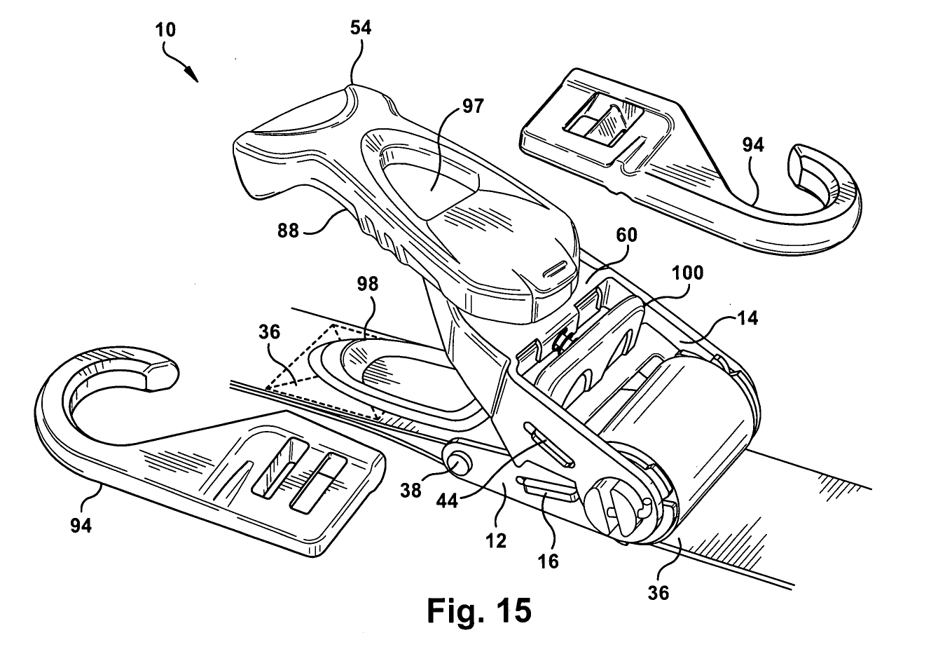

A restraint member 36, such as a strap or webbing, may be coupled to the base 12 by any appropriate means, such as by fasteners 38. Each sidewall 17 of the base 12 may include an aperture 34. The aperture 34 may be of any appropriate shape or size, such as of a generally circular shape, for example. The fasteners 38 may be of any appropriate shape, size or type, such as a bolt or rivet pin, for example. The fastener 38 may also be affixed on the other end of the strap 36 by another fastener 80, such as a nut, for example. The coupling of the strap or restraint member 36 to the base 12 allows the ratchet mechanism 10 to be secured to an anchor or other such fixed location. As best shown in FIG. 15, one or more hooks 94 may also be secured to the strap or restraint member 36 to facilitate securing the restraint member 36 to a fixed location.

The upper body 14 includes a pair of circular apertures 40 in opposing sidewalls 42 of the upper body 14. The circular apertures 40 of the upper body 14 align on the outside of the circular apertures 24 of the base 12, and the bails 26 are positioned in the apertures 40 of the upper body 14 to pivotably couple the upper body 14 to the base 12.

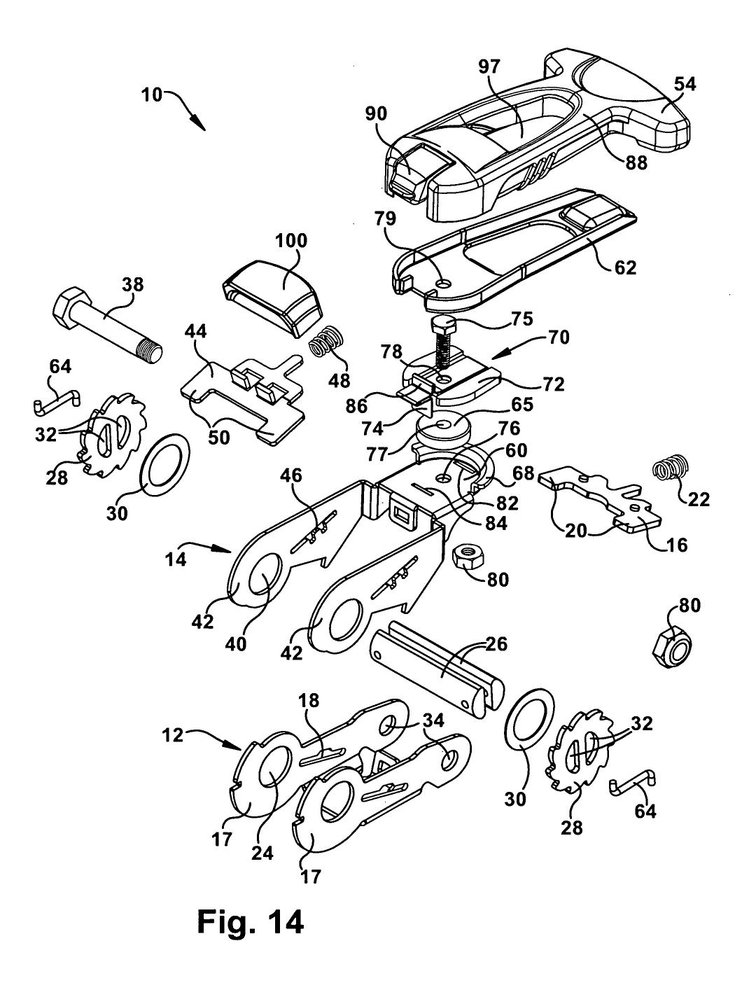

An upper pawl 44 is moveably positioned in the upper body 14 through two matching slots 46 in opposing sidewalls 42 of the upper body 14. As best seen in FIG. 14, tabs 50 extending from the upper pawl 44 are sized to fit into the pair of slots 46 in the upper body sidewalls 42. The tabs 50 and slots 46 are arranged to allow limited lateral movement of the upper pawl 44 with respect to the upper body 14 between extended and retracted positions. A spring 48 may be positioned behind the upper pawl 44, to bias the pawl 44 into a forward position. A release mechanism, or button, 100 is provided for selectively engaging and disengaging the upper pawl 44 with the gears 28.

As best seen in FIG. 14, the upper body 14 may also be provided with a lever 60, from which the sidewalls 42 extend. The lever 60 may be of any appropriate shape or size. The lever 60 is capable of allowing a user to operate the ratchet mechanism 10 to secure an item. The lever 60 may also be integrally formed with the upper body 14, or may be a separate part from the upper body 14. If the lever 60 is a separate part from the upper body 14, the lever 60 may be secured to the upper body 14 by any appropriate means, such as with fasteners, adhesives, and the like, for example.

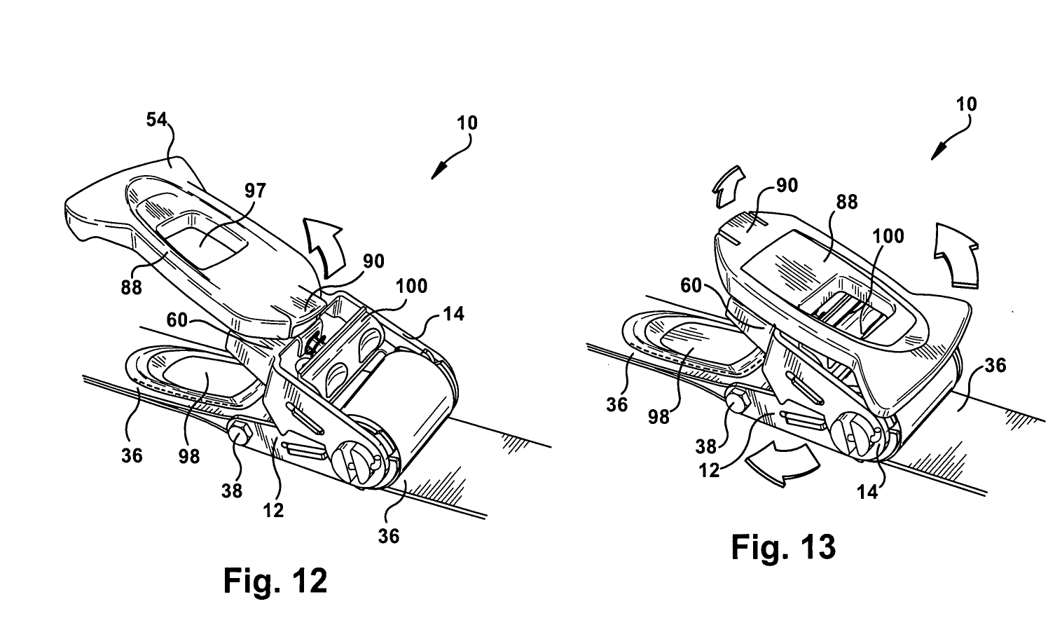

As shown in FIGS. 12 and 13, an extension member 62 may be rotatably secured to the lever 60 to increase the mechanical advantage of the ratchet mechanism 10. As shown in FIG. 14, a disc, or pivot puck, 65 may be positioned between the lever 60 and the extension member 62 to facilitate rotation of the extension member 62 between the compact and extended positions. A lip 68 may extend outwardly from the lever 60 to retain the disc 65 thereon.

The ratchet mechanism 10 may also include a locking mechanism 70. The locking mechanism 70 may retain the extension member 62 in the compact and extended positions.

The locking mechanism 70 may include a base 72 and a finger 74. For illustrative purposes only, the disc 65, the extension member 62, and the locking mechanism 70 may be rotatably secured to the lever 60 with a fastener 75 inserted through the apertures 76, 77, 78, and 79, as best shown in FIG. 14. The fastener 75 may be of any appropriate shape, size or type, such as a bolt, for example. The fastener 75 may then be secured by another fastener 80, such as a nut. It is understood, however, that one of ordinary skill in the art will appreciate that a variety of methods may be utilized for rotatably securing the extension member 62 to the lever 60.

With further reference to FIG. 14, the lever 60 may include slots 82 and 84. The slots 82, 84 may be capable of receiving the finger 74 therein. When in the compact position, the finger 74 may be inserted into the slot 82. When in the extended position, the finder 74 may be inserted into the slot 84. A lip 86 may be provided to allow an operator to withdraw the finger 74 from the slots 82 and 84. The cover 88 may be provided with a tab 90 connected to the lip 86, to allow an operator to lift the finger 74 from the slots 82, 84.

As shown in FIGS. 7-9 and 11-15, the mechanism 10 may further include a cover 88. An ergonomic cover 88 may be provided and connected to the extension member 62. The cover 88 may be positioned at any appropriate location on the mechanism 10, such as on the lever 60. The cover 88 may also be of any appropriate shape or size. It is to be understood that the cover 88 may be ergonomically shaped to aid in ease of use and be more comfortable for the user to operate the mechanism 10. The cover 88 may also be integrally formed with the lever 60 or may be a separate part from the lever 60. If the cover 88 is a separate part from the lever 60, the cover 88 may be secured to the lever 60 by any appropriate means, such as with fasteners, adhesives, and the like, for example.

As shown in FIGS. 7-9 and 11-15, the cover 88 (and extension member 62) may be provided with an aperture 97. The aperture 97 capable of allowing an operator to manipulate the release mechanism 100 when the extension member 62 is in the compact position, as shown in FIG. 13. The aperture 97 may allow the user to still pinch the release mechanism 100 in spite of the longer handle 60 length. In addition, the release mechanism 100 may be accessed regardless of handle or lever 60 position. As an alternative, an optional elastomer part could be attached to the rear strap to act as a leverage platform 98.

As illustrated in FIGS. 1, 4, 7 and 10-16, the mechanism 10 may further include a release mechanism or button 100. The button 100 may be of any appropriate shape or size, as shown in FIGS. 1, 4, 7 12 and 16. The button 100 may be positioned at any appropriate location on the mechanism 10, such as on the lever 60 or upper body 14, for example. The release mechanism or button 100 may be provided for selectively engaging and disengaging the upper pawl 44 with the gears 28. For example and illustrative purposes only, when the user desires to unload or unsecure the cargo or load, the user may push on the release mechanism or button 100 to do so. The release mechanism 100 may be configured to work with lever 60 via any appropriate means, such as by a spring.

The ratchet mechanism 10, as illustrated and described, may be used to secure cargo during transportation. A restraint member 36 such as a strap or webbing is positioned over cargo.

Ends of the restraint 36 are secured to suitable anchor points. Tension in the restraint member 36 sufficient to secure the cargo is generated by a ratcheting action of the upper body 14; i.e., rotating the upper body 14 between extended and retracted positions. In such an operation, a loose end 95 of the restraint is passed through a gap formed by the bails 26 such that little or no slack remains in the restraints 36.

The mechanism 10 may also include one or more ratchet wheels or gears 28. The ratchet gears 28 may be located at any appropriate location on the securing mechanism 10, such as on the bails or spool 26, for example. The ratchet gears 28 may be connected to the spool 26 to facilitate rotation of the spool 26 during a ratcheting operation. For example, the spool 26 may include one ratchet gear 28 located on either end of the spool 26, whereby the ratchet gears 28 may be located between the sidewalls 17 of the base 12 and the sidewalls 42 of the upper body 14, as illustrated in FIGS. 1, 4 and 7.

The securing mechanism 10 may also include one or more pawls 16, 44. The lower pawl 16 may be connected to the securing mechanism 10 by any appropriate means. For example, the lower pawl 16 may be provided along sidewalls 17. The lower pawl 16 may also be slidably connected to the sidewalls 17 and spring biased to engage the ratchet gears 28. In addition, an upper pawl 44 may be provided along sidewalls 42. The upper pawl 44 may also be slidably connected to the sidewalls 42 and spring biased to engage the ratchet gears 28.

As shown in FIG. 13, the operator grasps the lever 60 (and extension member 62 in the compact position) of the upper body 14 and rotates the upper body 14 about the bails or spool 26 between extended and retracted positions. As the upper body 14 is rotated, the upper pawl 44 may engage the gears 28 and rotate the gears 28 thereby indexing the gears 28 into the next gear position. This may result in the loose end of the strap 95 being pulled through the ratchet mechanism 10 and tension on the strap 36, 95 increasing.

The lower pawl 16 may engage the gears 28 to prohibit the gears 28 from rotating in the opposite direction as the upper body 14 is rotated between extended and retracted positions, thus preventing the loosed end of the strap 95 from unwinding and releasing tension. The more the upper body 14 is rotated, the higher the tension may be generated on the straps 36, 95.

Reciprocal motion of the lever 60 with the base 12 while the pawls 16, 44 are engaged with the ratchet gears 28 may cause the spool 26 to rotate. When the lever 60 is reciprocated, the strap 36 may be gathered onto the spool 26. The strap 36 may be gathered onto the spool 26 in any appropriate manner.

To increase the mechanical advantage of the ratchet mechanism 10, and to provide a handle that may be easier to manipulate, the extension member 62 may be adjusted into an extended position, as shown in FIGS. 1, 4, 12 and 16. The extension member 62 may be adjusted from a compact position into an extended position by any appropriate means, such as by rotating the extension member 62, pulling out the extension member 62, or the like, for example.

It is to be understood, however, that a variety of configurations may be provided for moveably securing the extension member 62 to the lever 60. For illustrative purposes only, as shown in FIGS. 1, 2, 4, 5, 12, 13, 16 and 17, the extension member 62 may be secured to the mechanism 10 or lever 60 by any appropriate means. For example, the extension member 62 may be hingedly secured to the lever 60. Accordingly, the extension member 62 may be extended from a compact position (as shown in FIGS. 2, 5, 13 and 17) to an extended position (as shown in FIGS. 1, 4, 12 and 16).

FIG. 11 illustrates the ergonomic cover 88 and how the cover 88 may be integrated with the extended handle or lever 60 and extension member 62. As shown in FIGS. 12 and 13, during operation of the ratchet mechanism 10, an operator may utilize an extension member 62 to extend the length of the lever 60 from a compact position to an extended position to increase the mechanical advantage of the lever 60. The lever 60 may be extend by any appropriate means. For example, to extend the length of the lever 60, the extension member 62 may be pulled out from a compact position to an extended position, as shown

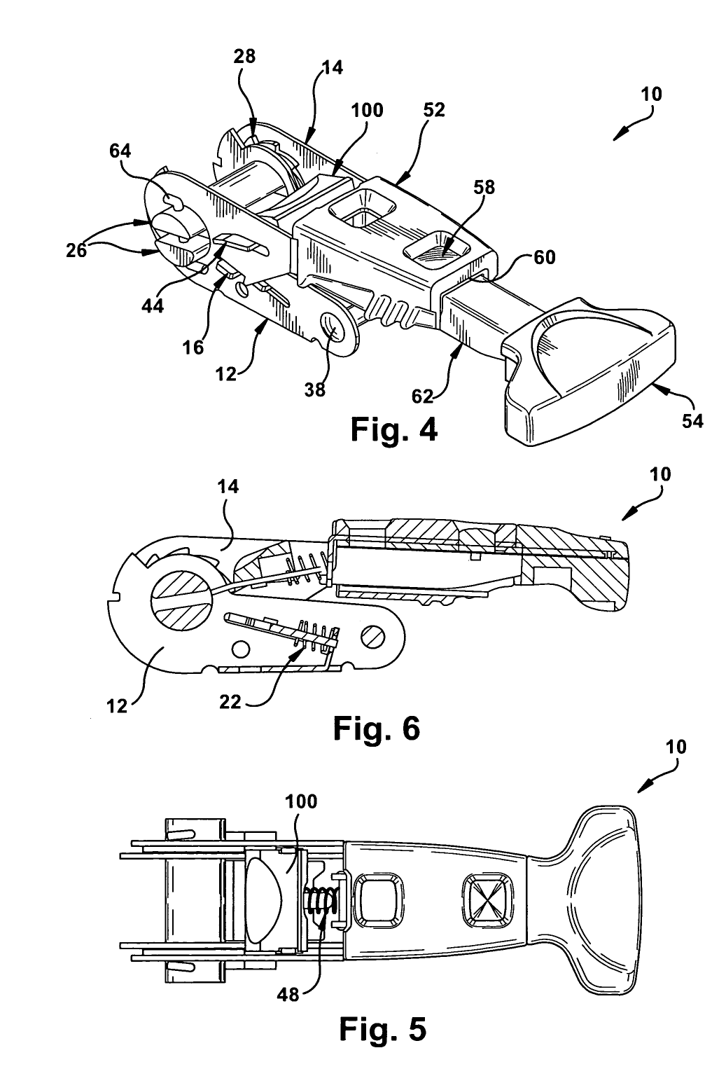

in FIGS. 1 and 4, or the extension member 62 may be rotated from a compact position to an extended position, as shown in FIGS. 7, 9, 12 and 13.

FIG. 13 shows the mechanism 10 fully assembled, with the lever or handle 60 in an extended position. The tab 90 may be lifted to unlock and pivot the extension member 62.

FIG. 14 shows the handle in a collapsed or compact position where the ratchet may still be used even while in this configuration.

For illustrative purposes only, the operator may lift the tab 90 to withdraw the finger 74 from the slot 82 and rotate the extension member 62 to the extended position, whereby the finger 74 disengages the slot 82 in order to engage the slot 84, thereby securing the extension member 62 in the extended position. Accordingly, extension member 62 provides a greater mechanical advantage in the extended position. It is to be understood, that after securing the items, the extension member 62 may be returned to the first position to minimize exposure.

As an alternative, the base 12 may also be provided with a non-abrasive material or soft plate (not shown). The soft plate may be comprised of any appropriate material, such as a polymer, plastic, rubber material, or the like, for example. The plate may be attached to the existing base 12 of the mechanism 10. The plate may be attached by any appropriate means, such as by snapping onto the base 12 or being attached by adhesives or the like, for example.

As a further alternative, the base 12 may be comprised of an overmolded base (not shown) that may protect any cargo from damage by the ratchet mechanism 10. As another alternative, the base 12 may include a non-abrasive coating or layer (not shown). The layer may be of a variety of appropriate non-abrasive materials, including, but not limited to cloth, plastics, rubber, and the like. It is to be understood that any portion or the entire mechanism 10 may be covered with such a layer.

As shown in FIG. 15, the securing mechanism 10 may also include one or more securing members 94, such as a hooks. The hooks 94 may be provided for securing the strap ends to any appropriate type of object, such as a vehicle, trailer, or the like, for example. As another example, the securing members 94 may be interchangeable so that, for example, a variety of different and appropriate configurations may be used, such as a flat hook, double hook, or the like.

The strap 36 may be made from any variety of appropriate materials, such as natural or synthetic materials for example. In a non-limiting example, the strap 36 may be shaped or fabricated from a material that will not fold and seize the spool 26, such as of a generally rectangular shape, as shown in the FIGS. In addition, as another alternative, the mechanism 10 may include one or more buckles (not shown). The buckles may be provided at any appropriate or desired location along the strap 36. The buckles may provide for additional adjustability.

In an alternative embodiment, the ends of the strap 36 may be reinforced by any appropriate means to prevent fraying, tearing, dragging, or the like, such as with a cover (not shown) that may be made from any variety of appropriate materials, including, but not limited to, metal, plastic, composites, and the like.

As another alterative, a cover (not shown) may be provided for the mechanism 10. A locking mechanism (not shown) may also be provided for the mechanism 10. The locking mechanism may protect the mechanism 10 from manipulation from unauthorized users or from any accidental manipulation due to the elements or while driving. The locking mechanism may include any appropriate type of locking, such as a traditional lock and key, a combination lock, or the like, for example.

It is also to be understood that a variety of other types of appropriate configurations or drives may be utilized with the spool 26. For example, instead of a ratchet configuration, the spool 26 may be rotated with a screw-type drive (not shown) to gather the strap 36 about the spool 26. Further, a tension indicator (not shown) may be provided for load-specific applications to indicate when a desired strap 36 tension is reached. In addition, a locking indicator (not shown) may be provided to indicate that the pawls 16, 44 are in a locked engagement with the ratchet wheels or gears 28.

As a further alternative, the mechanism 10 may include a quick-tightening feature (not shown) that may be used to tighten a majority of the strap 36 prior to gathering the strap 36 around the spool 26 via the ratcheting mechanism 10. The quick-tightening feature may be of any appropriate type of apparatus or device, such as a buckle.

For example, the ends of the strap 36 may be pulled through the quick-tightening feature thereby reducing the necessary amount of time and effort spent operating the ratcheting to secure the cargo or load. The quick-tightening feature may allow a large portion of the slack in the strap 36 to be cinched relatively tightly in seconds, such as prior to ratcheting and gathering the strap 36 onto the spool 26.

This ability to quickly tighten any excessive slack in the strap 36, such as prior to utilizing the ratchet mechanism, may reduce the overall time and effort required to reciprocate the lever 60 during the ratcheting process. The quick-tightening feature may also prevent too much of the strap 36 from being gathered onto the spool 26, which may hinder the ability of the spool 26 to effectively gather the strap 36. The final tightening may be done in the traditional fashion.

While the present invention is described with reference to embodiments described herein, the present invention is not limited to such embodiments. Therefore, the description of the embodiments herein is merely illustrative of the embodiments of the present invention and will not limit the scope of the invention as claimed. The invention has been described above and, obviously, modifications and alternations will occur to others upon a reading and understanding of this specification. The claims as follows are intended to include all modifications and alterations insofar as they come within the scope of the claims or the equivalent thereof.

Moreover, while the present ratchet mechanism 10 may be described in the context of retraining a load or cargo in association with a vehicle or trailer, it will be appreciated that the ratchet mechanism 10 may be used in any variety of contexts, and, as such, any reference to restraining cargo or use with trailer and vehicles is illustrative in nature and not restrictive in any way. In addition, the description of the embodiments provided may refer to the use of specific options or materials, however, this should not limit the scope of the invention as claimed. Those skilled in the art will understand that the above descriptions should only be taken as illustrative.

Having thus described the invention, we claim:

1. A ratchet mechanism comprising:
a body configured to receive a strap;
a pair of opposing arms connected to said body;
a spool rotatably connected to said opposing arms, said spool configured to wind said strap;
at least one ratchet wheel connected to opposing ends of said spool;
a lever attached to said arms and reciprocated between an open position and a closed position, wherein said lever includes at least one pawl to engage said at least one ratchet wheel and rotate said spool when said lever is reciprocated; and
wherein said lever is extendable away from said spool to increase the mechanical advantage of said lever.

2. The ratchet mechanism of claim 1 further comprising a release mechanism capable of selectively disengaging said pawl from said ratchet wheel.

3. The ratchet mechanism of claim 2, wherein said release mechanism is connected to said lever.

4. The ratchet mechanism of claim 3, wherein said lever includes a handle rotatably connected to said lever.

5. The ratchet mechanism of claim 4, wherein said handle is rotatable between a first position, wherein said handle is located closer to said spool, and a second position, wherein said handle extends further away from said spool.

6. The ratchet mechanism of claim 5, wherein said release mechanism is connected to said lever.

7. The ratchet mechanism of claim 3, wherein said lever includes a handle slidably connected with said lever.

8. The ratchet mechanism of claim 7, wherein said handle is slidable between a first position, wherein said handle is closer to said spool, and a second position, wherein said handle extends further away from said spool.

9. A ratchet mechanism comprising:
a body configured to receive a strap;
a pair of opposing arms connected to said body;
a spool in rotatable engagement with said opposing arms, said spool capable of winding said strap;
a pair of ratchet wheels connected to opposing ends of said spool;
a lever attached to said arms and reciprocated between an open position and a closed position, wherein said lever includes at least one pawl to engage said ratchet wheels thereby rotating said spool when said lever is reciprocated; and
a handle having a first end rotatably connected to said lever and a second end capable of rotating about said first end to extend the length of said lever and increase the mechanical advantage of said lever.

10. The ratchet mechanism of claim 9, wherein said handle is rotatable between a compact position wherein said second end is closer to said spool, and an extended position, wherein said second end is extended further away from said spool.

11. The ratchet mechanism of claim 10 further comprising a pivot puck positioned between said handle and said lever, said puck capable of facilitating rotation of said handle.

12. The ratchet mechanism of claim 10, wherein said handle is lockable in said compact position.

13. The ratchet mechanism of claim 10, wherein said handle is lockable in said extended position.

14. The ratchet mechanism of claim 11, further comprising a release mechanism capable of selectively disengaging said pawl from said ratchet wheel.

15. A ratchet mechanism comprising:
a body configured to receive a strap;
a pair of opposing arms connected to said body;
a spool in rotatable engagement with said opposing arms, said spool capable of winding said strap;
a pair of ratchet wheels connected to opposing ends of said spool;
a lever attached to said arms and reciprocated between an open position and a closed position, wherein said lever includes at least one pawl to engage said ratchet wheels thereby rotating said spool when said lever is reciprocated; and
a handle slidably connected to said lever, said handle slidable between a compact position wherein said handle is closer to said spool, and an extended position wherein said handle extends further away from said spool.

16. The ratchet mechanism of claim 16, wherein said handle is lockable in said compact position and in said extended position.

17. The ratchet mechanism of claim 17 further comprising a release button to release said handle form said lockable positions.
